(19) United States
(12) Patent Application Publication
(10) Pub. No.: US 2009/0112657 A1
(43) Pub. Date: Apr. 30, 2009

(54) REPOSITORY INFRASTRUCTURE TO STORE TRANSACTION INFORMATION FOR PROVIDING CUSTOMER SERVICE

(75) Inventors: Albhy Galuten, Santa Monica, CA (US); Peter Douma, Wyckoff, NJ (US)

Correspondence Address: Trellis Intellectual Property Law Group, PC, 1900 EMBARCADERO ROAD, SUITE 109, PALO ALTO, CA, 94303, US

(73) Assignees: SONY CORPORATION, Tokyo (JP); SONY ELECTRONICS, INC., Park Ridge, NJ (US)

(21) Appl. No.: 12/022,971

(22) Filed: Jan. 30, 2008

Related U.S. Application Data
(60) Provisional application No. 60/983,035, filed on Oct. 26, 2007.

(51) Int. Cl. G06Q 99/00; G06Q 10/00

(52) U.S. Cl. 705/7; 705/1

(57) ABSTRACT

Particular embodiments generally relate to providing customer service recommendations. A first business entity may provide customer care for a user of a device. For example, the first business entity may have manufactured the device. The user of the device may participate in many transactions during use of the device. The transactions may be with other devices and/or services. When these transactions are performed, information for these transactions may be stored in a repository. At some point, the user may encounter problems with the operation of the device. The user may contact customer care for the first business entity and allow access to the transaction information. Thus, the first business entity may be able to review transactions that occurred with business entities other than itself.

### CROSS REFERENCE TO RELATED APPLICATIONS

This application claims priority from U.S. Provisional Patent Application Ser. No. 60/983,035, entitled REPOSITORY INFRASTRUCTURE TO STORE TRANSACTION INFORMATION FOR PROVIDING CUSTOMER SERVICE, filed on Oct. 26, 2007, which is hereby incorporated by reference as if set forth in full in this application for all purposes.

### BACKGROUND

Particular embodiments generally relate to computing and security and more specifically to consumer electronic devices and media services.

Users may purchase a device and/or service from a first manufacturer. It is expected that this device may interact with other devices and/or services. For example, a portable music player may download songs from an Internet download service. During the use of the device, the user may experience problems. One solution for the user is to call customer service. In this case, the user may call customer service for the device or the Internet download service. Because these two entities may be associated with different business entities, the customer service provided to the user may not be satisfactory. For example, the manufacturer of the device may tell the user that it is not the device's problem but the problem is being caused by the interaction with the Internet download service. However, when the user calls the Internet download service, the user may receive the same message that it is not their problem. Accordingly, because the user has a device that is interacting with other devices and/or services, individual customer care entities from different entities may not be able to solve the problem being experienced by user on their own.

### SUMMARY

Particular embodiments generally relate to providing customer service recommendations. A first business entity may provide customer care for a user of a device. For example, the first business entity may have manufactured the device. The user of the device may participate in many transactions during use of the device. The transactions may be with other devices and/or services. For example, a user may download music or videos from a second business entity. Also, user may use the device to communicate with other devices, such as other devices in a home network. When these transactions are performed, information for these transactions may be stored in any number of places, such as on the device, at a location designated by the device manufacturer, designated by the service provider, in a location designated by the user, in a repository or any combination of the above. The information may be securely stored and the user or their designee may specify who can access the secure information and when.

At some point, the user may encounter problems with the operation of the device. Because the device may interact with other devices and/or services, the user may not be able to isolate the problem. However, the user may contact customer care for the first business entity and allow access to the transaction information. For example, the user may send secure information to the first business entity to allow that business entity to access the transaction information in a central or distributed repository. Thus, the first business entity may be able to review transactions that occurred with business entities other than itself. For example, a transaction with a second business entity and the device may be analyzed to determine any problems that may have occurred. Once a problem is isolated, a customer service recommendation for the device may be provided. Thus, the first business entity may provide customer service recommendations using information that is associated with transactions with other business entities. This may eliminate the problem of business entities indicating that the problems experienced by the user are associated with other business entities. This may also provide better customer service for the user and also build goodwill for the first business entity.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a simplified system for providing customer care recommendations according to one embodiment.

FIG. 2 depicts a simplified flowchart for storing transaction information in repository 108 according to one embodiment.

FIG. 3 depicts a simplified flowchart of a method for providing customer care recommendations according to one embodiment.

FIG. 4 depicts a simplified flowchart of a method for receiving transaction information for a user.

FIG. 5 depicts a more detailed example of the system according to another embodiment.

FIG. 6 depicts a more detailed example of system according to one embodiment.

FIG. 7 describes a simplified flowchart of a method for determining the transaction ID according to one embodiment.

### DETAILED DESCRIPTION OF EMBODIMENTS

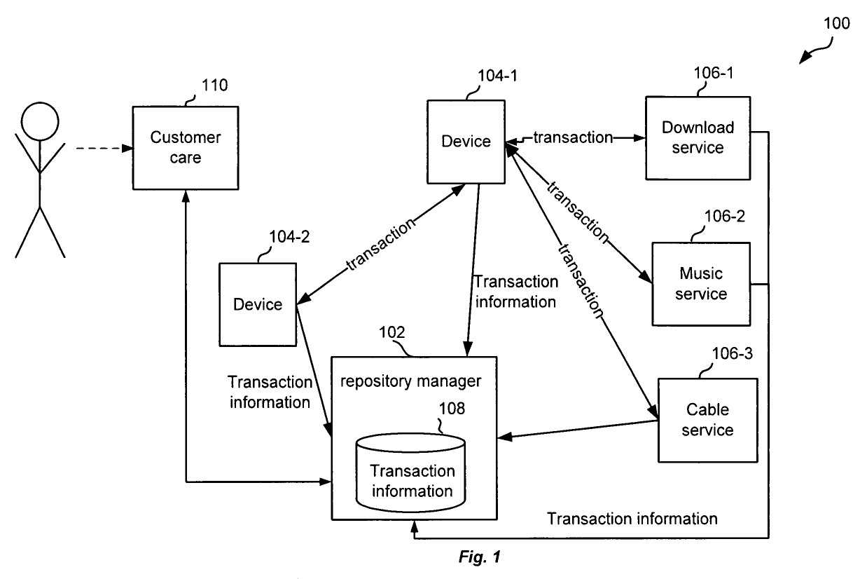

FIG. 1 depicts a simplified system 100 for providing customer care recommendations according to one embodiment. As shown, a repository manager 102, devices 104, and services 106, a repository 108, and a customer care provider 110 are provided.

Devices 104 may be any computing devices. For example, devices 104 include portable music players, personal computers, laptop computers, cellular phones, set-top boxes, televisions, etc. In one example, a user may own multiple devices 104 from different business entities.

Services 106 may be any service that may be provided to devices 104. For example, the services may include Internet download services, such as the downloading of music and/or video, video-on-demand services, etc. In one example, services 106 may be associated with different business entities than a manufacturer of device 104-1. The chances that a user may have devices that interact with devices and/or services from different business entities may be high. Accordingly, to be able to provide customer care for devices that interact with other devices is important.

Repository 108 may store information for a user that may allow customer care recommendations to be provided. The information that is stored may be transaction information when a user performs transactions using a device 104-1. The transactions may be with other devices 104-2 and/or services 106. Although a single repository 108 is shown, it will be understood that multiple storage devices may be used and information stored may be distributed among storage devices that are in different locations.

In one embodiment, device 104-1 may be associated with a first business entity, such as the manufacturer of the device. The device may interact with other devices 104-2 and/or services 106. This may be different from standalone devices that may not have been used with other devices. That is, with networking, devices can now interact with other devices and services; however, previously, devices may not have communicated with other devices. In the standalone case, when the device did not work, the manufacturer of the device could determine the problem with the operation of the device because the problem may be isolated to just the use of the device only. However, other devices 104-2 and/or services 106 may be associated with other business entities. Thus, customer service for the first business entity that manufactured device 104-1 may not be able to determine what the problem is unless they have information of how device 104-1 interacted with other devices and/or services.

Activity information for a user may be stored in a number of places so that customer-care recommendations to be provided. The may be stored on or at:
Individual devices
On hard drives of other devices in my home network
On dedicated storage on my home network
At a repository on line (e.g. leased hard disc space) controlled by a user
At a repository online controlled by a service provider (e.g. from whom I bought content)
At a repository online controlled by a customer-care service provider designated by a user
At any number of service providers that make their specific information available to a user or my representative (e.g. my designated service provider) including services provided by manufacturers that may store usage information associated with individual devices

This information may be collected by any of the entities (subject to consumer permission) and stored any of the places listed above. For example a music service may keep a record of the purchase transactions, licenses (for DRM protected content) and file distribution records that could be required if a music file does not play (e.g. Did my credit card clear? Did I get the license? Where is the license? Did I get the file? Where is the file? Etc.). A device may keep a record of what licenses and files were delivered to it and where they were stored. Additionally devices in the home network (portable devices, PCs, home servers, game machines, etc.) may track what files and or licenses were transferred to what devices. Additionally devices and software applications may want to track their versioning status including when updates were performed.

Because devices 104 and services 106 may be associated with different business entities, a central customer care infrastructure is provided. When a transaction is performed between device 104-1 and device 104-2 and/or services 106, transaction information may be stored in repository 108. The transaction information may be received from device 104-1 itself and/or devices 104-2/services 106.

The information stored in repository 108 may be securely stored for a user. For example, the user may be able to provide permission to an entity to review the transaction information in repository 108; however, without this permission, customer care provider 110 cannot access the information.

When a problem is encountered with device 104-1, a user can contact customer care provider 110. The user may contact customer care provider 110 in different ways, such as through email, instant message, telephone, etc. The user can then provide customer care provider 110 permission to access repository 108. The information may be accessed and then analyzed to determine a problem that has occurred with device 104-1. For example, transaction information between service 106 and device 104-1 may be analyzed. This transaction information may be associated with a second business entity that is different from the first business entity associated with device 104-1. Conventionally, this information may not have been available to customer care provider 110. However, using repository 108 or a group of distributed repository using commonly defined interfaces, this information is stored and available to customer care provider 110 upon permission from the user. Thus, customer care recommendations may be provided that may otherwise not been able to have been determined using the transaction information in repository 108.

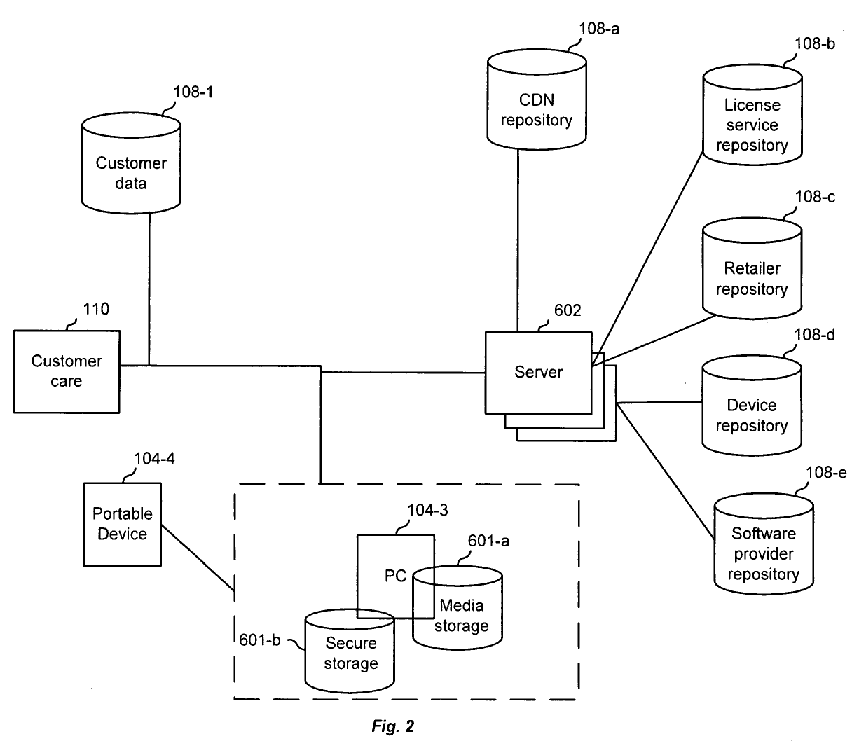

FIG. 2 depicts a more detailed example of system 100 according to one embodiment. Device 104-3 may be a personal computer (PC) or other sophisticated computer operating environment. Storage 601-a is the media storage area of the PC. Secure storage 601-b is the secure metadata storage area of the PC. Device 104-4 is a portable device that can be used for playing audio or video files. Customer care provider 110 is the provider of customer care. This could be a representative from a device manufacturer, a retail service provider or a dedicated customer care provider.

Customer repository 108-1 stores customer data, which may be local to a consumer on their home network or online at a service provider. Transaction repositories 108-a-108-e are a family of transaction record data repositories that can be queried to find out data about the various transactions and the state of the various devices. There may be many of these for multiple device manufacturers, retailers, and service providers. These entities may be value chain participants, which may be entities that participate in some way in the transaction.

Repository 108-a is the CDN (Content Delivery Network) transaction data repository. Records of files that were distributed may be stored here. For example, if a movie was delivered to a user, the user information, such as the device to which it was delivered and the directory in which it was stored, may be stored. If the customer care representative wants to know if a file was delivered and where it was delivered to, this is the database that could be queried.

Repository 108-b is the license service transaction data repository, which may store records of distributed licenses. Licenses may be the permissions associated with the use of a media file and may include the key for decrypting them. For example, if a movie was delivered to a user, this database would store the delivery information, such as the device to which it was delivered and the directory in which it was stored. The customer care representative can query this repository to determine if a license was delivered and where it was delivered to.

Repository 108-c is the retail transaction data repository. This is where the original transaction ID would be stored and associated with that transaction ID would be the information about the retail transaction; for example, information on whether the transaction (e.g. credit card) successful, whether a trigger generated to cause the issuance of a license, whether a trigger generated to cause the delivery of the media file and were these triggers acknowledged as having been received and acted upon.

Repository 108-d is the device database. This is generally maintained by the customer care representatives of the manufacturer of the device in question (though it could be housed by anyone with whom the customer registers; e.g. a consumer electronics retail store or a dedicated customer support company).

Repository 108-e is the software and software version database. This database includes information on which devices have what versions of which software. This is generally maintained by the customer care representatives of the developer of the software in question (though it could be housed by anyone with whom the customer registers; e.g. a consumer electronics retail store or a dedicated customer support company).

A customer care representative may be from any of the value participants (retailer, device manufacturer, CDN, license issuer, dedicated customer care service, etc.). When the consumer contacts their customer care representative (by any means including phone, email, instant messaging, etc.) the following series of events may take place. The representative asks for permission from the consumer to access their data records as stored at the various representatives (retailers, license services, etc.). The customer gives the representative that permission. That permission could be given in writing, over the phone or electronically. Security may be a component of this permission and the actions that follow, which will be described in more detail below.

Once the customer care representative has permission, different repositories can be queried (108-a thru e) for relevant data. The repositories may be queried through various servers 602. Different things can be determined to provide customer care:
Did the transaction succeed at the retailer (e.g. did the credit card clear)? There may be a transaction ID stored on the consumer's device (e.g. their PC). This transaction ID could be stored in a specific place for transaction IDs, in the DRM secure database or in a cookie associated with the browser. In the case of a cookie, when the transaction begins at the retailer, the retail web site leaves a cookie in the cookie repository for the browser used for the transaction. This cookie can then be read later by the appropriate application to determine the transaction ID. The transaction ID may be needed to determine which transaction the customer care agent is interested in.
Was the License service contacted to issue the customer a license and if it was, was the license issued and to what device and what location (directory, etc.)?
What is the location of the license service should it need to be contacted by the customer care provider 110?
Was the CDN contacted to deliver the file and if it was, was the file received and to what device and what location (directory, etc.).
What is the location of the CDN should it need to be contacted by t customer care provider 110?
What is the model number of the device and what version of firmware is running on the device (or what OS and version number if a PC)? The end user may need to input a serial number for this to happen or a software application on the device may need to query the device to determine this.

What software may be involved in the processes at hand (e.g. DRM, media player, download manager, etc.) and what versions of that software? The end user may need to input a serial number for this to happen or may have to run the software to find this out manually.

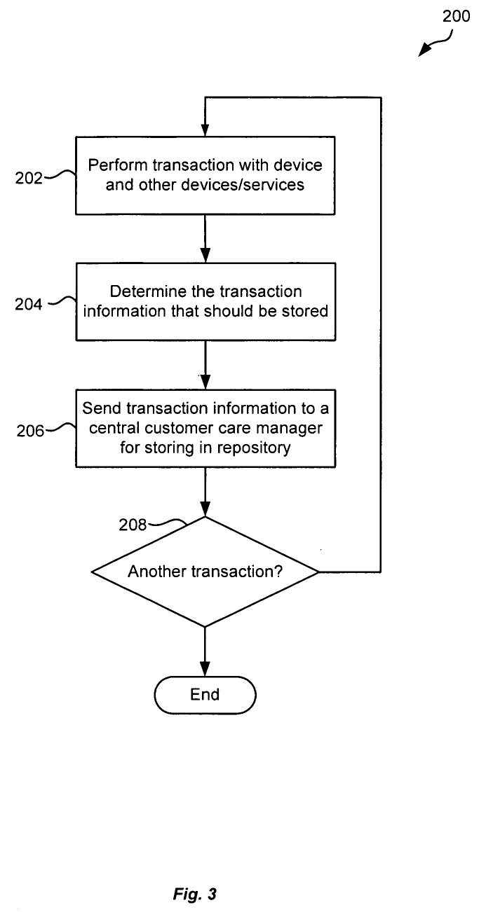

The process of determining customer care recommendations will be described in more detail. The process involves storing information in repository 108 and later accessing the information to determine and provide recommendations. In one example, a user may purchase a device 104-1 from a first business entity. For example, a user may purchase a portable music player from a first manufacturer. The user will then use the device in various transactions where transaction information may be stored for the transactions. For example, FIG. 3 depicts a simplified flowchart 200 for storing transaction information in repository 108 according to one embodiment.

In step 202, a transaction is performed with device 104-1 and other devices 104-1/services 106. The user may first login and create an identity for the customer care program. For example, the user logs in at a retailer, device manufacturer, service provider, etc. The user is given a Customer Care ID (CCID) and password and downloads a browser plug-in that contains a Certificate identifying the user. When the user makes a purchase, the browser presents the certificate that stipulates the Customer Care ID and retrieves a Transaction ID, a Retailer ID and content metadata from the retail web site.

During the transaction, information may be exchanged or actions may be performed. For example, the user may download a file from service 106. The download of the file may include many different steps, such as the transfer of a license, the transfer of payment information, etc. Step 204 determines the transaction information that should be stored, such as a log of the different steps that occur in the transaction. Also, the user may perform actions using device 104-1, such as pressing play on the portable music device, saving a file to a directory, etc. This information may also be determined as transaction information.

In step 206, transaction information is sent to a central (or one of a number of distributed) customer care managers 102 for storing in repository 108. For example, service 106-1 and/or device 104-1 may store transaction information in repository 108. In one embodiment, the browser plug-in stores the Transaction ID, Retailer ID and relevant metadata for later use if necessary. Also, other devices/services may cause the storing, such as intermediary routers, billing gateways, etc. Because different entities are storing transaction information, a transaction ID may be used to allow central customer care manager 102 to associate the information together for a single transaction. The information received from service 106-1 and device 104-1, and may also be protected. For example, a secure key, certificate, etc. may be used to send the information related to the transaction to customer care manager 102. This ensures that any confidential information may be protected for a user.

In step 208, it is determined if more transactions are performed. If so, the process reiterates to step 202 and additional transaction information may be stored in repository 108.

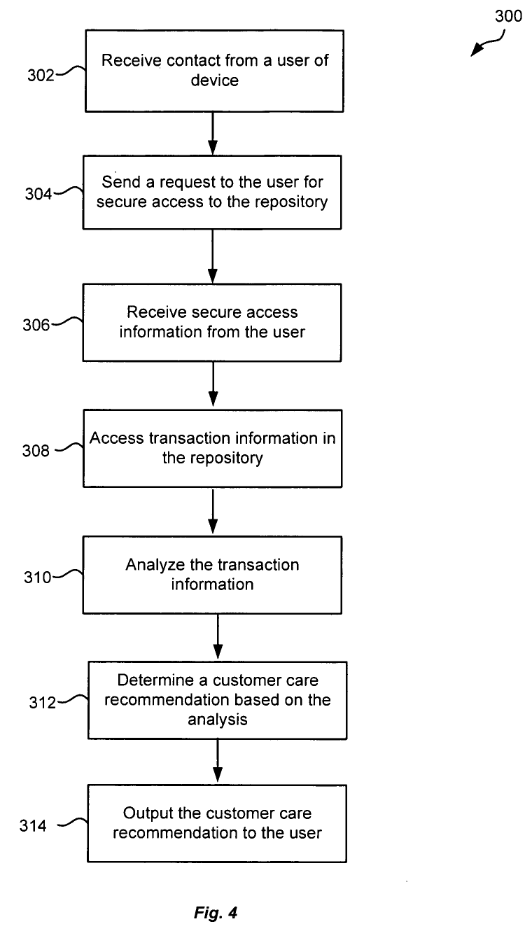

Once the information is downloaded into repository 108, it may be accessed to provide customer care for a user. FIG. 4 depicts a simplified flowchart 300 of a method for providing customer care recommendations according to one embodiment. The customer care may be provided by customer care provider 110. Customer care provider 110 may be associated with device 104-1 and/or service 106-1. Also, customer care provider 110 may also be a third party that is not related device 104-1 or service 106-1.

Step 302 receives contact from a user of device 104-1. For example, a user may call customer care provider 110, may send an e-mail, may instant message, etc.

Step 304 sends a request to the user for secure access to repository 108. For example, customer care provider 110 may request that the user provide them with permission to access repository 108. The permission may be time limited or data limited. For example, the permission may expire after a time period or allow access to a limited set of data.

Step 306 receives secure access information from the user. For example, the user may copy and paste a link into an instant message window, send an e-mail with a link providing the secure information, or otherwise provide a secure password to a customer care representative. The secure information may include a certificate, key, or any other information that may be used to access secure transaction information in repository 108. In one example, the customer care ID, transaction ID and certificate may be presented along with a password.

In step 308, transaction information may be accessed in repository 108. For example, a transaction ID and the secure information may be used to access transaction information associated with the user in repository 108. The transaction ID may be used to identify the transaction. The access permission provided to customer care provider 110 may allow access to all of the transaction information associated with a user or only a portion of it. For example, a user may own many different devices and only the transaction information associated with device 104-1 may be accessed. Also, the user may specify which transaction information may be accessed. The access may also be based on problem-related heuristics. For example, access to credit card information might not be needed if the problem has to do with the network or delivery of the content and not if the content was paid for by the user.

Step 310 then analyzes the transaction information. For example, the transaction information may be analyzed automatically to determine if any problems occurred during transactions with device 104-1. In one example, the problem may be when the user presses play on device 104-1, a song/movie does not play. The problem may be analyzed to determine if a file was ever transferred, a license was received, software on device 104-1 needs to be updated, credit card information was correctly transferred, etc.

Step 312 then determines a customer care recommendation based on the analysis. The customer care recommendation may specify certain steps a user may take to rectify a problem. The transaction information may be processed using a rules engine. For example, the transaction information may be analyzed to automatically determine a customer care recommendation.

Step 314 then outputs the customer care recommendation to the user. For example, the customer care recommendation may automatically be sent to the user through e-mail, instant message, etc. Further, the customer care recommendation may be displayed to a customer care representative, and that customer care representative may discuss the problem with the user.

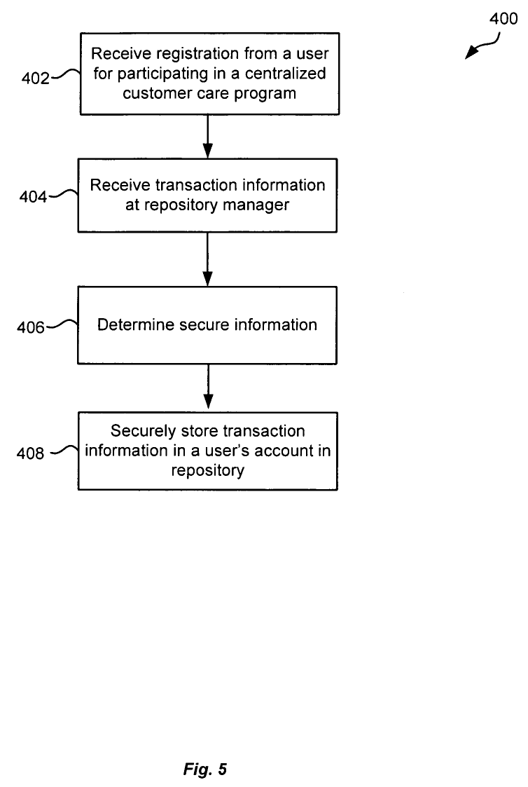

To provide the service to a user, many different business entities may need to provide transaction information to repository 108. In this case, an infrastructure may be provided to allow services 106 and/or devices 104 to send transaction information to repository 108. FIG. 5 depicts a simplified flowchart 400 of a method for receiving transaction information for a user. Step 402 receives registration from a user for participating in a centralized customer care program. For example, a user may provide information to repository manager 102 that may allow for transaction information to be securely stored. The user may specify which devices 104 user owns and which services 106 are currently being used. This may allow repository manager 102 to contact various services and devices to alert them to send user transaction information for storage in repository 108. Accordingly, this may alleviate having services 106 and devices 104 continually sending transaction information for all transactions that are performed. In this case, transaction information may be focused according to user preferences.

In step 404, transaction information is received at repository manager 102. Transaction information may be received from various services 106 and devices 104.

In step 406, secure information may be determined. For example, the transaction information may be securely sent. Thus, privacy and confidentiality for the user may be maintained. In step 408, transaction information is securely stored in a user's account in repository 108. A transaction ID may also be associated with the transaction information. For example, the secure information may be used to store the information in the user's account. Thus, it is expected that other users will not be able to access the transaction information for the user. Also, in order to access the information, the user may have to provide permission by sending the secure information to the other entity. Limited use keys may be provided to allow access to content. Also, certificates for customer service agents may be used to verify that they are indeed certified as customer service agents.

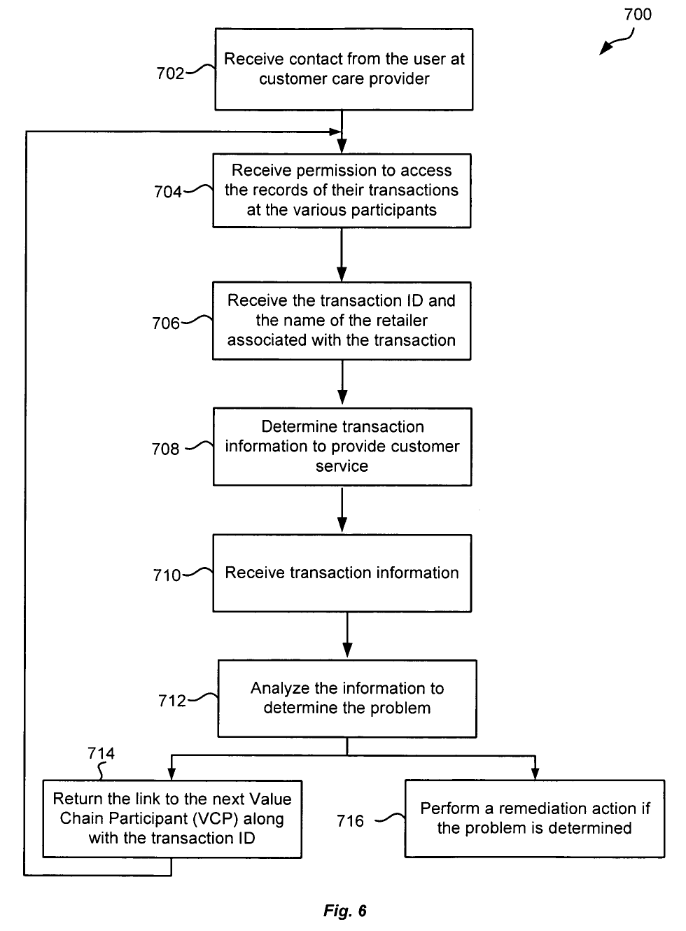

As discussed above, transaction IDs are used to find the correct transaction. Customer care provider 110 may need to know the retailer (or subscription service provider) and the transaction ID to provide the proper advice. The transaction ID is the link between retail transaction and the customer care event. Once customer care provider 110 has the transaction ID, it is presented to the retailer or their representative to retrieve the data necessary for the resolution of the problem. FIG. 6 describes a simplified flowchart 700 of a method for determining the transaction ID according to one embodiment. Step 702 receives contact from the user at customer care provider 110. Step 704 receives permission to access the records of their transactions at the various participants. This access may be limited as described below in the section on security. For example, secure information may be transferred to customer care provider 110.

Step 706 receives the transaction ID and the name of the retailer associated with the transaction. In one embodiment, customer care provider 110 may read a cookie or retrieve data from the secure DRM database.

Step 708 determines transaction information to provide customer service. For example, once customer care provider 110 has the retailer and the transaction ID, this can be presented to the retailer, who can query their database (or give customer care provider 110 access to it) to answer the various questions above.

Step 710 receives transaction information. Step 712 analyzes the information to determine the problem. If the transaction information is not sufficient (e.g. they do not know if the license was served by the license service), step 714 returns the link to the next Value Chain Participant (VCP) along with the transaction ID (signed by the retailer). Another value chain participant may be contacted and the process reiterates to step 704. The process can continue through all the VCPs until the cause of the problem is uncovered.

Step 716 performs a remediation action if the problem is determined. A remediation action may be taken as a result of the investigation to solve the problem. Once the problem is found the appropriate entity must be contacted and the appropriate action taken. Actions may include re-issuing a license to the consumer's device. In this case, the problem is defined (likely as expressed electronically in XML) and presented to the retailer who issues a new license trigger either to customer care provider 110 who forwards it on to the user or to the user directly. Also, if the payment mechanism was declined, the user is redirected to the retailer where new payment information can be given and the transaction can be started over again. If a file was never delivered, a new deliver trigger is requested from the retailer. Also, if the file was delivered but has been lost or overwritten, a new delivery trigger may be delivered. If the version of software (e.g. DRM, media player, etc.) is not current, a link to the proper software or firmware update service is delivered. Finally, if device 104 does not have the appropriate credentials, the user is directed where to get the proper credentials or if that is not possible is informed that transfer can not be made to that device.

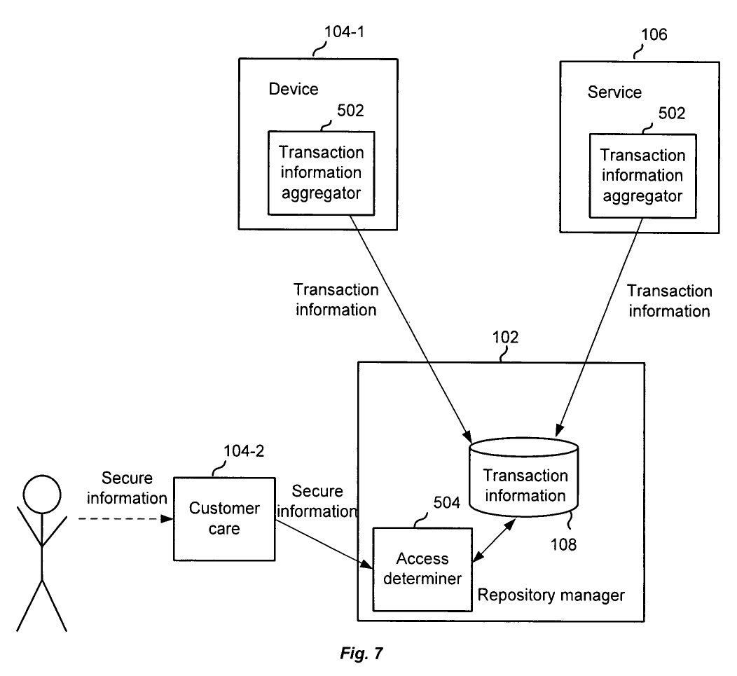

FIG. 7 depicts a more detailed example of system 100 according to another embodiment. As shown, device 104-1 and service 106-1 may participate in a transaction. Although service 106-1 is depicted, the transaction may be performed with another device 104. During the transaction, different information may be exchanged and events may be performed based on the type of transaction. For example, different events that may be tracked for software include: the function performed (e.g., media playing) and vendor and software version for an application or embedded software being used. Also, for content sales, a status of secure proof of purchase may be provided if it was sent, when it was sent, where it was sent, or why it was not sent may be included. Also, a status of receipt of the secure proof of purchase may be provided as in a license trigger in a browser or at a license server, and also if a license was sent/received and when the license was sent and to where, and also when the license was received and where it was stored. Other information may be when a file was sent and where it was sent to, where the file was received and where it was stored. Additionally, other information may be: was a file transferred, copied, burned to a CD, and if so, how many times, when, where, etc.

For subscription-based services, the status of all subscriptions may be included in transaction information. Also, for home networks, any registered domains, registered devices in the domains, and when a file is transferred to one of these devices may be provided.

A transaction information aggregator 502 may aggregate this information in a transaction history. Transaction information aggregator 502 may then send it to customer care manager 102 for storage in repository 108. The transaction information received from different sources may be correlated together using a transaction ID.

When a user wants to contact customer care, it may contact customer care provider 110. The user can provide secure information to allow access to transaction information. Customer care provider 110 may use the secure information to access transaction information in repository 108. For example, secure information may be sent to an access determiner 504, which can then access repository 108 to determine transaction information associated with the user. Access determiner 504 then determines which information can be accessed. For example, a user may desire that only a portion of the information be accessed depending on the problem being troubleshooted. The transaction information may then be returned to customer care provider 110 for analysis to provide customer care recommendations.

Accordingly, a user may contact customer care associated with a business entity. This business entity may analyze transactions that may have been performed with other business entities. The transaction information is stored in a repository in which a user may give permission to the business entity to access. This may allow better troubleshooting of a problem because devices may interact with other devices and/or services that are associated with different business entities. Whereas, if the business entity did not have access to this information, it may not be able to troubleshoot the problem.

Security may be used in performing customer care. This may ensure the customer's information is private. Also, retailers may not want to share their customer information and so the access to the customer records should not only be based on permission from the user but should be limited to that data needed to solve the problem at hand and should not be retained after the problem is resolved. Consequently, the data may need to be functionally limited—that is only those records that are needed—and time limited—that is only for a prescribed period of time. Certificates (likely X-509) may be used to make the attestation that I (the service provider—including the content care rep) am who I say I am. If a service provider is not on a white list other service providers should not speak with them.

Additionally, customer care provider 110 may make an attestation that they are approved to provide the service they say they are going to provide. The companies that work together in this network may have a process for determining that some one is in fact a “retailer” or a “customer care service provider” or a “license service” and those assertions should be provided electronically, probably as SAML (Security Assertions Markup Language) assertions.

A transaction ID for the transaction may have been generated. Also, a retailer ID may also be associated with the retailer that was associated with the purchase. A user may sign using an assertion the IDs, which may be passed to a digital rights manager (DRM). The DRM may already have that information and can hand it directly to customer care provider 110 (assuming the DRM is a participant in the system). In another scenario, the transaction ID and the retailer ID are left on the user's device as a “cookie”. The cookie may include the identity of the retailer and the location (URL) where customer care assertions should be presented. These cookies may be encrypted and may include a clear text (unencrypted) representation of where customer care provider 110 should present their credentials.

Customer care provider 110 may receive the assertion. The assertion may allow customer care provider 110 to access the transaction information. By presenting the assertion, customer care provider 110 is saying I am company X (as attested to by my certificate) and I am on your white list, I am allowed to do customer care (as attested to by my SAML assertion), and I am representing this customer's wishes as attested to by his signature (for which you have acquired the public key when you did the original transaction). Additionally, customer care provider 110 is stating I have an assertion (signed by the customer) that I would like the specific information requested (likely in a predefined XML schema). Customer care provider 110 may ask for a particular granularity, e.g. I have the original license because the file was played on the user's PC but an additional license for a second device was not received and my query is with regard to the additional license.

The assertion is used by the retailer to determine which transaction information to access. For example, the assertion includes the transaction ID and that is used to determine the information. The retailer may include the user's public key and that can be used to decrypt the assertion. The transaction ID for the user may need to be associated with the retailer. When the user visits the retail web site, a device 104 receives a unique ID or personality. The user may be given “customer care” ID in that creates a machine personality (this is a standard mechanism whereby a combination of characteristics of a PC are used to create a unique identity). This may have already been performed by the DRM. On a consumer electronics device (like a portable media player), other mechanisms are used to “personalize” the device—a unique ID—usually by either putting a unique number in a secure place on the device at the time of manufacture or by personalizing the device by connecting it to a DRM personalization service when the device is first used. This Unique ID (UID) is used to identify device 104 that made the original purchase.

The unique ID may be used to create either a certificate and/or a private key (PKI) for device 104. The private key can be used to encrypt communications between the user's device 104 and customer care provider 110. The certificate can be used to sign communications to affirm that they came from the same device 104 that made the original transaction.

The binding (that is cryptographic association with the entity needing the customer care service) can also be done to the user or to an account. Certificates and Private Keys can be generated from association with other elements associated with the User or Account like user ID and password, fingerprint, retinal scan, etc.

Once the retailer knows to whom or what the content was sold, the entity (customer care provider 110) can be associated by the retailer with the transaction ID of every transaction. In this way, when another entity appears asking for data about the transaction, the retailer can know that the request was authorized by the entity that made the original purchase.

In the event that customer care provider 110 needs to query an entity down the line from the retailer—e.g., a license service—customer care provider 110 retrieves a certificate from them that gives customer care provider 110 permission to have the data records associated with a particular transaction that the service (e.g. license service) has done on the retailer's behalf.

Although the description has been described with respect to particular embodiments thereof, these particular embodiments are merely illustrative, and not restrictive. Although customer care is described, it will be understood that the repository may be used for other purposes, such as for sales. For example, the transaction information may be used to recommend other devices and/or services to a user.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for providing customer care, the method comprising:
receiving a request for customer care from a user of a device associated with a first business entity;
receiving access information from the user, the access information usable to access a repository of transaction information for the user;
using the access information to access transaction information for the user from the repository, the transaction information including information relating to one or more transactions performed using the device with a second business entity different from the first business entity;
determining a customer service recommendation based on the transaction information; and
outputting the customer service recommendation for the device based on the transaction information.

2. The method of claim 1, wherein the transaction information includes a transaction performed with the device and a second device associated with the second business entity.

3. The method of claim 2, wherein the transaction information is received from the device and/or the second device.

4. The method of claim 1, wherein the transaction information includes a transaction performed with the device and a service associated with the second business entity.

5. The method of claim 4, wherein the transaction information is received from the device and/or the service.

6. The method of claim 1, wherein the transaction information is used to determine if operation of the device was performed correctly.

7. The method of claim 1, wherein the access information comprises a customer identifier received from the user, the customer identifier allowing access to the transaction information.

8. The method of claim 7, wherein the customer identifier is encrypted by an assertion that attests to a possessor to have permission to access the transaction information.

9. The method of claim 8, wherein the assertion includes a transaction ID, the transaction ID usable to determine the transaction information and the assertion usable to indicate permission is granted to access the transaction information.

10. Software encoded in one or more computer-readable media for execution by the one or more processors and when executed operable to:
receive a request for customer care from a user of a device associated with a first business entity;
receive access information from the user, the access information usable to access a repository of transaction information for the user;
use the access information to access transaction information for the user from the repository, the transaction information including information relating to one or more transactions performed using the device with a second business entity different from the first business entity;
determine a customer service recommendation based on the transaction information; and
output the customer service recommendation for the device based on the transaction information.

11. The software of claim 10, wherein the transaction information includes a transaction performed with the device and a second device associated with the second business entity.

12. The software of claim 11, wherein the transaction information is received from the device and/or the second device.

13. The software of claim 10, wherein the transaction information includes a transaction performed with the device and a service associated with the second business entity.

14. The software of claim 13, wherein the transaction information is received from the device and/or the service.

15. The software of claim 10, wherein the transaction information is used to determine if operation of the device was performed correctly.

16. The software of claim 10, wherein the access information comprises a customer identifier received from the user, the customer identifier allowing access to the transaction information.

17. The software of claim 16, wherein the customer identifier is encrypted by an assertion that attests to a possessor to have permission to access the transaction information.

18. The software of claim 17, wherein the assertion includes a transaction ID, the transaction ID usable to determine the transaction information and the assertion usable to indicate permission is granted to access the transaction information.

19. An apparatus configured to provide customer care, the apparatus comprising:
means for receiving a request for customer care from a user of a device associated with a first business entity;
means for receiving access information from the user, the access information usable to access a repository of transaction information for the user;
means for using the access information to access transaction information for the user from the repository, the transaction information including information relating to one or more transactions performed using the device with a second business entity different from the first business entity;
means for determining a customer service recommendation based on the transaction information; and
means for outputting the customer service recommendation for the device based on the transaction information.
